(19) United States
(12) Patent Application Publication
(10) Pub. No.: US 2010/0053439 A1
(43) Pub. Date: Mar. 4, 2010

(54) SYSTEMS AND METHODS FOR NATURAL COLOR GAMUT VIEWING MODE FOR LASER TELEVISION

(76) Inventor: Takao Konishi, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/544,833

(22) Filed: Aug. 20, 2009

Related U.S. Application Data
(60) Provisional application No. 61/093,323, filed on Aug. 31, 2008.

(51) Int. Cl. H04N 5/50; G09G 5/02; H04N 9/64

(52) U.S. Cl. 348/569; 345/590; 348/649; 348/E09.037; 348/E05.097

(57) ABSTRACT

Systems and methods that facilitate a reduced color gamut viewing mode and, more particularly, a user selectable and activity assignable reduced color gamut viewing mode for laser light source based televisions.

### CROSS-REFERENCE TO RELATED APPLICATION

This application claims the benefit of provisional application Ser. No. 61/093323 filed Aug. 31, 2008, which is fully incorporated herein by reference.

### FIELD

The embodiments described herein relate generally to color signal processing for laser light source based televisions and, more particularly, to systems and methods that facilitate a user selectable and activity assignable reduced color gamut viewing mode for laser light source based televisions.

### BACKGROUND INFORMATION

Televisions typically use three primary colors, red, green and blue, which define a RGB color space. In addition to employing the RGB color space, televisions typically employ a specific color gamut. While the color space defines colors (i.e., a relationship between colors) the color gamut represents a range of possible colors that can be reproduced by mixing the primary colors. A television utilizing a laser light source has a significantly larger color gamut than a conventional television due to the characteristics of the laser light source. Although the large color gamut of a laser based television can be used to show a large variety of colors or reproduce more “brilliant” colors on the display screen, users may prefer the color gamut of a conventional television. Thus, it is desirable to provide a viewing mode that utilizes a reduced color gamut similar in characteristics to conventional televisions.

### SUMMARY

The embodiments provided herein are directed to systems and methods that facilitate a reduced color gamut viewing mode and, more particularly, a user selectable and activity assignable reduced color gamut viewing mode for laser light source based televisions. In one embodiment, a television includes a video display screen coupled to a control system. The control system includes a micro processor and non-volatile memory upon which system control software is stored, an on screen display (OSD) controller coupled to the micro processor and the video signal input connections, an image display engine coupled to the OSD controller and the display screen, and a laser light source coupled to the micro processor and the image display engine. The micro processor includes a color signal processing module or apparatus for mapping the color coordinates of each pixel of the input video signal to color coordinate values within a selected color gamut of the television.

In another embodiment, individual color gamut settings could be saved per each activity for a preferred viewing experience for a given activity. For example, the user of a combination device providing gaming and movie capabilities (e.g., Playstation 3, XBOX360 and others) could have separate color gamut settings for each activity such as “Play Game” and “Watch Movie”.

Other systems, methods, features and advantages of the example embodiments will be or will become apparent to one with skill in the art upon examination of the following figures and detailed description.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a laser light source based television with an integrated sound projector and control system.

FIG. 2 is a graphical representation of showing the color gamuts for alternative modes of operation of a laser light source based television.

FIGS. 3A and 3B are graphical representations illustrating the mapping of input color signal to the color gamut of the television.

FIG. 4 depicts a graphical user interfaced based menu displayed on the screen of the television with a color option drop down menu displayed.

FIG. 5 depicts a graphical user interfaced based menu displayed on the screen of the television with a activities drop down menu displayed.

FIGS. 6A and 6B are schematics of the television screen showing alternative activity selection menus in a graphical user interface.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

The systems and methods described herein are directed to a laser light source based television with a user selectable and activity assignable reduced color gamut mode viewing option. More particularly, as provided in the embodiments described herein, the television includes a menu-based control system that is navigatable by the user through a graphical user interface wherein the user can select alternative color gamut viewing modes. The television can be setup or programmed to assign alternative color gamut viewing modes to different activities such as “Watch Movie”, “Watch Sports”, “Play Games”, etc.

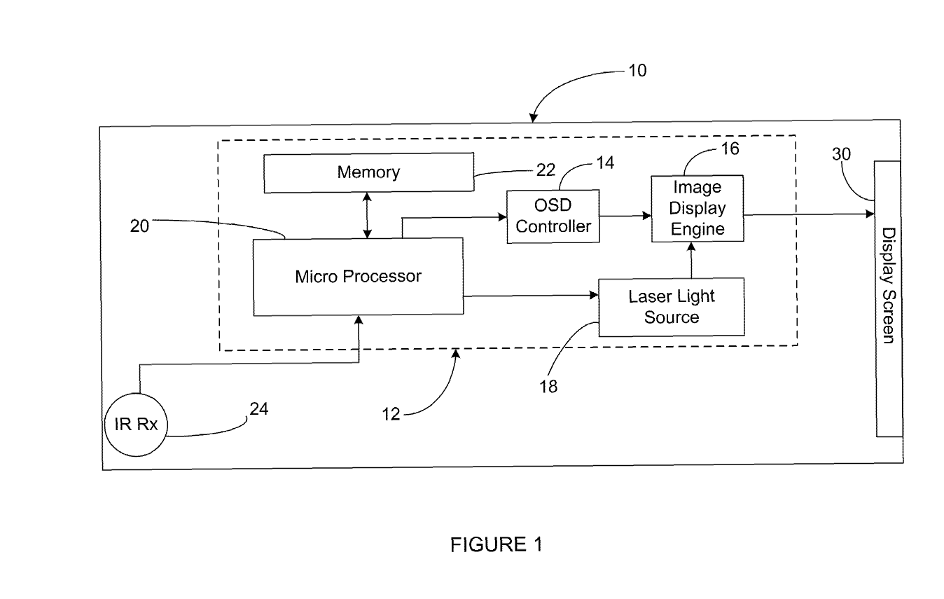

Turning in detail to the figures, FIG. 1 depicts a schematic of an embodiment of a television 10. The television 10 preferably comprises a video display screen 30 and an IR signal receiver 24 coupled to a control system 12. The control system 12 preferably includes a micro processor 20 and non-volatile memory 22 upon which system software is stored, an on screen display (OSD) controller 14 coupled to the micro processor 20, an image display engine 16 coupled to the OSD controller 14 and the display screen 30, and a laser light source 18 coupled to the micro processor 20 and the image display engine 16. The micro processor 20 preferably includes a color signal processing apparatus or module, which may include a software module included in the system software, that maps the color coordinates of each pixel of the input video signal to color coordinate values within the color gamut of the television 10.

The system software preferably comprises a set of instructions that are executable on the micro processor 20 to enable the setup, operation and control of the television 10. The system software provides a menu-based control system that is navigatable by the user through a graphical user interface displayed or presented to the user on the television display 30. While on the television layer of the television remote control unit, the user can navigate the graphical user interface to setup, operate and control the television 10 and external A-V input devices, such as, e.g., a DVD, a VCR, a cable box, and the like, coupled to the television 10. A detailed discussion of a graphical user interface-based menu control system and its operation is provided in U.S. Published Patent Application No. US 2002-0171624 A1, which is incorporated herein by reference. The '624 application describes the menu-based control system and its operation with regard to the centralized control of audio-video components coupled to a television and controlled using a menu-based control system with a graphical user interface.

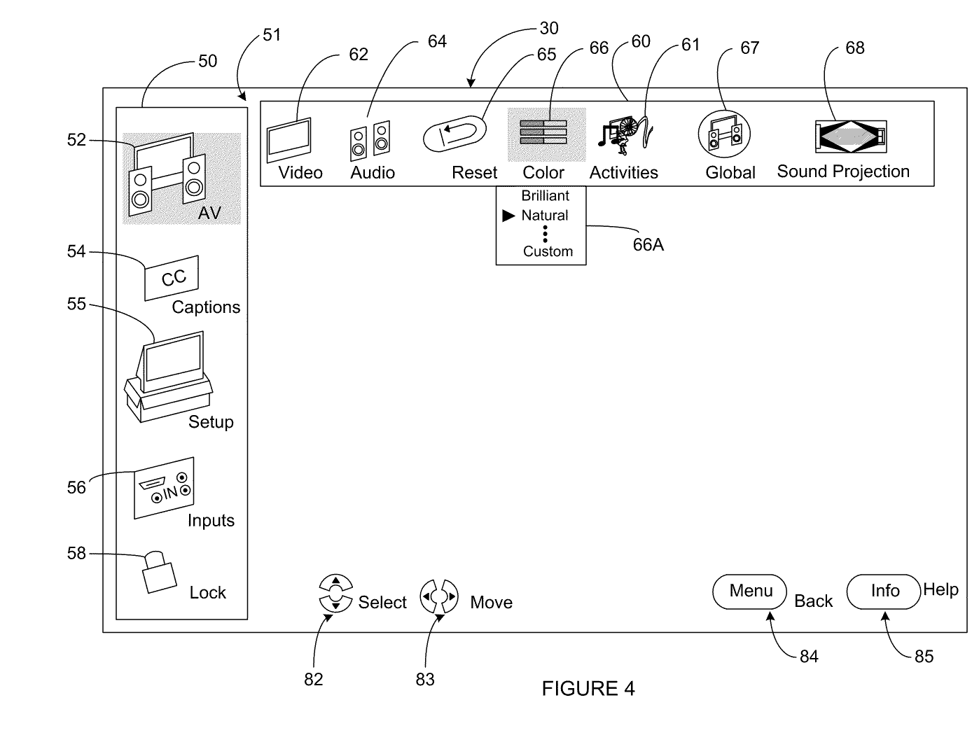

In operation, the user using the menu system and graphical user interface 51 (see FIG. 4) displayable on the screen 30 of the television 10 and generated by the system software executed on the micro processor 20, can select between different color gamut viewing modes of operation including “brilliant”, “natural” and the like. Using the graphical user interface based menu system, the user can also create alternative color gamut viewing modes.

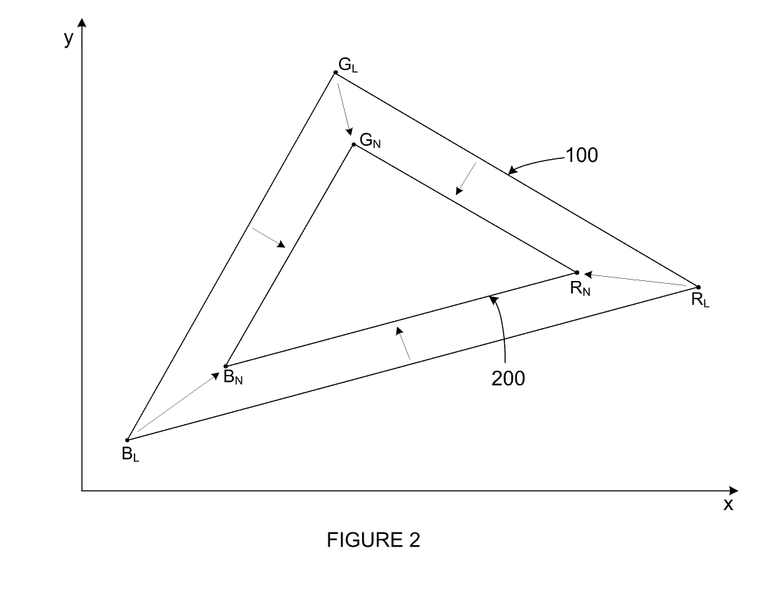

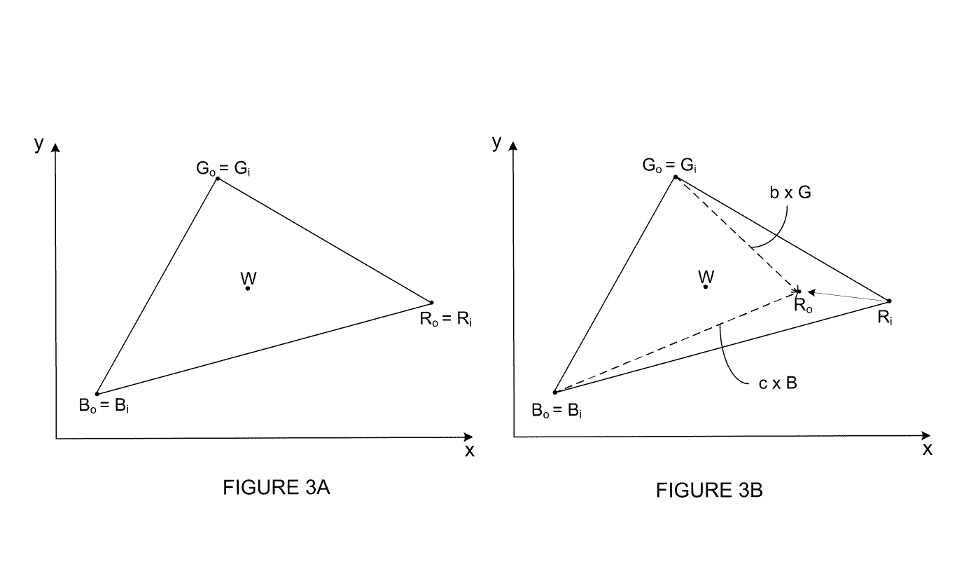

Turning to FIG. 2, two color gamuts of the television 10, including a full (“brilliant”) color gamut 100 and a reduced (“natural”) color gamut 200, are depicted. The full color gamut 100 extends between color coordinates R_{L}G_{L}B_{L} and corresponds to the characteristics of the laser light source 18. The reduced color gamut 200 extends between color coordinates R_{N}G_{N}B_{N}. The color coordinates R_{N}G_{N}B_{N} are reduced or adjusted from color coordinates R_{L}G_{L}B_{L} as depicted in FIGS. 3A and 3B.

The color coordinates R_{O}G_{O}B_{O} defining the output color gamut are calculated as follows:

R_{O}=Rᵢ+(a*R+b*G+c*B) (1.0)

G_{O}=Gᵢ+(a*R+b*G+c*B) (2.0)

B_{O}=Bᵢ+(a*R+b*G+c*B) (3.0)

where R_{O}=Red output; Rᵢ=Red input; G_{O}=Green output; Gᵢ=Green input; B_{O}=Blue output; Bᵢ=Blue input. If a=b=c=0, then R_{O}=Rᵢ; G_{O}=Gᵢ; B_{O}=Bᵢ. If as shown in FIG. 3A, to shift the red color toward the white point W, b and c are increased. To shift the blue color and green color toward the white point W, a and c are increased and a and c are increased, respectively.

Referring to FIGS. 4, 5, 6A and 6B, configuring or selecting the color gamut viewing mode using the television's graphical user interfaced-based multi-layer menu system will be discussed. Upon pressing the menu key on a control panel on the television 10 or on a remote control unit, the user is presented with a system configuration menu 50 preferably along the left side of the screen 30. The configuration menu 50 preferably comprises selectable graphical icons representing menu options corresponding to functions and/or devices the user can configure such as, e.g., AV devices 50, captions 54, “out of the box” system setup 55, input devices 56 and security systems 58. The user is also presented with a navigation key or guide indicating which keys to press on the remote control to accomplish navigation functions such as “select” 82, “move” 83, “back” 84 and “help” 85. Highlighting, as depicted using gray shading about the icon for the AV device 52 menu option, is used to indicate location within a menu and selected menu item.

Upon selecting the AV device 52 menu option in the system configuration menu 50, a device configuration menu 60 is preferably displayed along the top of the screen 30. The device configuration menu 60 preferably includes selectable graphical icons representing menu option corresponding to functions such as, e.g., viewing activities 61, video 62, audio 64, reset 65, picture color 66, internet 67, sound projection 68 and the like.

As depicted in FIG. 4, the user can select a color gamut mode of operation by selecting the Color icon 66 in AV device configuration menu 60. When Color icon 66 is selected, a color gamut mode selection drop down menu 66A or the like is displayed prompting the user to select a desired color gamut mode of operation. If “Brilliant” mode is selected, the control system of the television will causes images to be displayed on the display screen using the full color gamut of the television corresponding to the characteristics of the laser light source. However, if “Natural” mode is selected, the control system of the television will cause images to be displayed on the display screen using a reduced color gamut corresponding to the characteristics of a color gamut for a conventional television. By selecting “Custom” mode, the user is able to adjust the primary colors of the color gamut to create a customize color gamut which the control system uses to display images on the display screen.

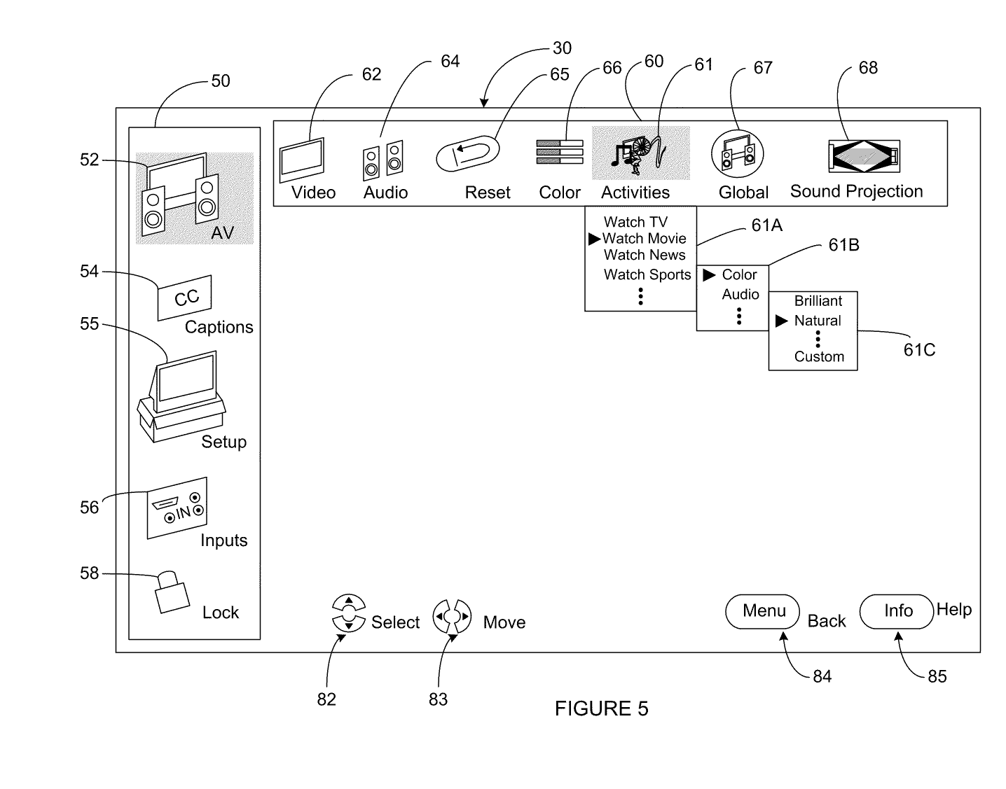

In another embodiment, preferred color gamut settings can be assigned and saved to different viewing experiences or activities. For example, activities such as “Watch News”, “Watch Movie”, “Watch Sports”, “Play Games”, etc. As depicted in FIG. 5, the user can assign a color gamut mode of operation to a particular activity by selecting the Activities icon 61 in the AV device configuration menu 60. When Activities icon 61 is selected, an activities selection drop down menu 61A or the like is displayed prompting the user to select a desired activity. If, e.g., “Watch Movie” is selected, an activity configuration drop down menu 61B or the like is displayed prompting the user to select a viewing or a listening option, or the like, to configure for the selected activity. If the color option is selected, a color gamut mode selection drop down menu 61C or the like is displayed prompting the user to select a desired color gamut mode of operation which is saved in memory and assigned to the selected activity. If “Brilliant” mode is selected, the control system of the television will cause images to be displayed on the display screen using the full color gamut of the television corresponding to the characteristics of the laser light source. However, if “Natural” mode is selected, the control system of the television will cause images to be displayed on the display screen using a reduced color gamut corresponding to the characteristics of a color gamut for a conventional television. By selecting “Custom” mode, the user is able to adjust the primary colors of the color gamut to create a customize color gamut which the control system uses to display images on the display screen.

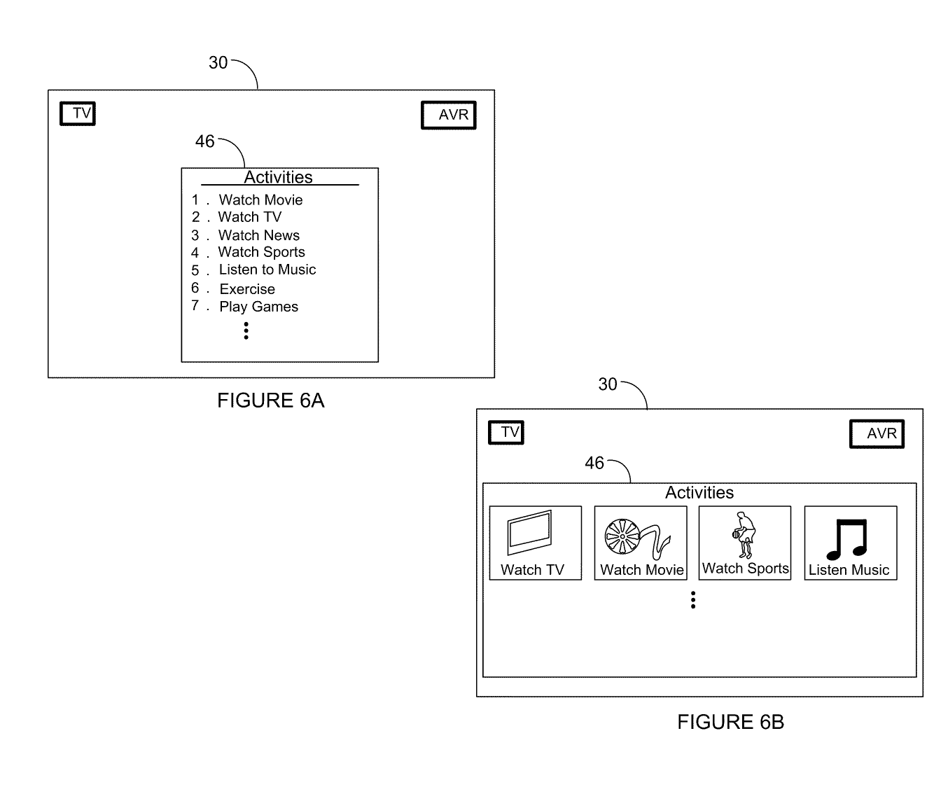

Such viewing activities can be presented, as depicted in FIGS. 6A and 6B, in an activities menu 46 on the television display screen 24 or on the remote control display screen, by selecting a dedicated activities or task key on a control panel on the television or on a remote control. When a particular activity is selected, the control system of the television causes images to be displayed on the display screen using the color gamut assigned to the particular activity. Preferably, by selecting a particular activity the television and connected device associated with the particular activity such as, e.g., a DVD for watching a movie, will automatically turn-on and implement preferred connections and settings for the activity selected. For example, if “Watch Movie” is selected, the followings actions will take place:
1. Blueray player is powered on;
2. Television is on and Blueray player is selected as input source;
3. Movie video settings such as color gamut mode are applied;
4. The AVR is switched to surround mode;
5. The volume is demuted.

Saving and assigning the color gamut mode of operation to particular activities is particularly useful where a multi-mode device like a media center PC, Playstation 3, XBOX360 etc. is present and can be used to play a game, watch a movie, view photos, etc., and the user has a desire to setup the activity preferences different per device activity mode, i.e., “Play Game”, “Watch Movie”, etc. When the media center PC gets selected to play a 3D game (“Play Game” in activity menu), the television preferably goes into it's 3D mode settings, if available. When the media center PC is used to playback a BluRay movie (“Watch Movie” activity menu), the television implements its movie watching settings and disables the 3D settings in this instance. Thus, the user of a combination device providing gaming and movie capabilities (Playstation 3, XBOX360 and others) could have separate optimized color mode settings for each activity “Play Game” and “Watch Movie”.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A process of viewing an input video signal on a display screen of a television comprising the steps of
receiving an input video signal; and
mapping the color coordinates of each pixel of the input video signal to color coordinate values within a selected color gamut for the television, wherein the selected color gamut is one of a full color gamut of the television and a reduced color gamut of the television; and
displaying the color gamut mapped input video signal on the display screen of the television.

2. The process of claim 1 further comprising the step of prompting a user to select between full color gamut viewing and reduced color gamut viewing.

3. The process of claim 2 further comprising the step of prompting user to select a viewing activity, and wherein the step of prompting the user to select between full color gamut viewing and reduce color gamut viewing includes prompting the user to select between full color gamut viewing and reduced color gamut viewing for the selected viewing activity.

4. The process of claim 3 further comprising the step of assigning the selected color gamut viewing mode to the selected viewing activity.

5. The process of claim 4 further comprising the steps of
receiving instructions to commence a user selected viewing activity, and
mapping the color coordinates of each pixel of the input video signal to color coordinate values within a selected color gamut for the view activity.

6. The process of claim 1, wherein the television includes a laser light source.

7. A process of viewing an input video signal on a display screen of a television comprising the steps of
receiving instructions to commence a user selected viewing activity,
receiving an input video signal; and
mapping color coordinates of each pixel of the input video signal to color coordinate values within a color gamut assigned to the view activity, wherein the assigned color gamut is one of a full color gamut of the television and a reduced color gamut of the television.

8. The process of claim 7 further comprising the step of assigning a color gamut viewing mode to each of a plurality of viewing activities.

9. The process of claim 8 wherein the step of assigning a color gamut viewing mode to each of a plurality of viewing activities includes
prompting a user to select a viewing activity, and
prompting the user to select between full color gamut viewing and reduce color gamut viewing for the selected viewing activity.

10. The process of claim 7, wherein the television includes a laser light source.

11. A television comprising
a video display screen,
an image display engine,
a control system coupled to image display engine, and
a laser light source coupled to the control system and the image display engine,
wherein the control system includes a color signal processing module that maps the color coordinates of each pixel of the input video signal to color coordinate values within a color gamut of the television selectable by a user.

12. The television of claim 11 wherein the control system includes a micro processor and an on screen display (OSD) controller coupled to the micro processor, wherein the image display engine is coupled to the OSD controller and the display screen.

13. The television of claim 11 wherein the control system includes a menu based user interface that is configured to prompt a user to select between full color gamut viewing and reduced color gamut viewing.

14. The television of claim 11 wherein the control system includes a menu based user interface that is configured to prompt a user to select a viewing activity.

15. The television of claim 14 wherein the a menu based user interface that is configured to prompt a user to select between full color gamut viewing and reduced color gamut viewing for the selected viewing activity.

16. The television of claim 8 wherein the control system includes a menu based user interface that is configured to prompt a user to select between full color gamut viewing and reduced color gamut viewing.
